(19) United States
(12) Patent Application Publication
(10) Pub. No.: US 2015/0146353 A1
(43) Pub. Date: May 28, 2015

(54) CABLE AND BACKPLANE SYSTEM FOR CONNECTING MULTIPLE HARD DRIVES TO A COMPUTER

(71) Applicant: Protocase Inc., Sydney (CA)

(72) Inventors: Stephen R. J. MacNeil, Glace Bay (CA); Douglas I. Milburn, Sydney (CA)

(21) Appl. No.: 14/550,213

(22) Filed: Nov. 21, 2014

Related U.S. Application Data
(60) Provisional application No. 61/907,057, filed on Nov. 21, 2013.

(51) Int. Cl. G06F 1/16

(52) U.S. Cl. CPC G06F 1/16
USPC 361/679.02

(57) ABSTRACT

Disclosed is a cable and backplane system for mounting a wiring system that permits connection of hard drives directly to a mother board of a computer. There is provided a mechanical backplane having multiple retainers defined in a top surface thereof. There is also a cable having a first end and a second end, the first end of the cable being mounted to one retainer in the mechanical back plane such that the first end can receive a hard drive, and the second end connectable to be in communication with the motherboard. A fastener is attached to the first end, the fastener anchoring the cable to the retainer to anchor the one or more hard drives. The fastener can be in the form of tabs to receive mounting screws to screw the first end to the retainer on the mechanical back plane, or in the form of clips or shanks to allow the hard drive to snap into place during use. In one embodiment, the mechanical backplane is a C-channel shape and the multiple retainers are configured to be in a row.

### FIELD

Embodiments of this invention relate to computing devices, and in particular to an improvement in connecting multiple hard drives to a computer. Specifically embodiments of the invention deal with SATA and SAS hard drive connections.

### BACKGROUND

Traditionally, each hard drive had to be connected to an individual SATA or SAS interface port. Commonly computers would have less than 4 hard drives, and thus computers are typically built with 4 to 6 ports. Ports may be physically part of the motherboard, or an add-on SATAISAS interface board. However, there is presently an explosion in the amount of data storage, driven by dropping prices on hard drives and storage intensive applications like images and video. This requires more hard drive ports, which increases system cost and consumes computing resources.

Thus storage servers and pods with large numbers of hard drives are becoming increasing necessary. The need for increased storage was addressed some years ago with the introduction of a backplanes. The primary function of a backplane is to multiplex multiple hard drives, in a manner such that they can be connected to one data port on the computer. For example, FIG. 1 illustrates a typical backplane 10 which is the basis for the conventional method of adding multiple hard drives (not shown) to a server (not shown). The backplane 10 of FIG. 1 connects 16 hard drives, and combines them into 2 connections (actually each set of 8 is combined into one port.) Another common configuration is a backplane that connects 5 drives to one port.

Another major function of backplanes is that they physically mount/constrain connectors, such that they constrain the connector end of the hard drive and can form part of a hard drive physical mount in a computer. (Traditionally. hard drives were physically mounted. and the cabling and connectors had nothing to do with restraining the drive.)

Most hard drives were cabled via ‘standard SATA cables’. One cable connected the data connector on the hard drive. to its corresponding interface port on the computer. The next innovation was the 8087 connector which combined the data connections for four SAS/SATA ports (SFF8482 connectors). These connectors can be used to fan out from a single 8087 4 port connection to four hard drives via 4 SFF8482 connectors (the connector on the other end can be 8087's, or ‘standard SATA/SAS data connectors). These cabling advances only reduce the number of connectors, but NOT the number of ports.

Host bus adaptors (HBA's) are interface cards that provide multiple SATA/SAS ports and connect them to the computer's internal busses. Recent advances have seen the introduction of faster and larger (in terms of number of ports) HBA's.

When adding multiple hard drives to a server, the conventional method is to use a backplane 10 as pictured in FIG. 1. The backplane 10 of FIG. 1 has a requirement for drivers and for special software with circuitry 20 to initialize the drive array.

Although such backplanes are advantageous in reducing the number of ports required through multiplexing, their major drawback is that the bandwidth of the connection is shared through across multiple drives on a single port.

Another drawback of traditional backplanes is that they increase parts count and system complexity. This increases failure modes and reduces reliability, relative to direct cabling from drive to port.

Another obstacle is that backplanes are constantly being upgraded or go End of Life. This requires a change in design as the product matures, creating multiple versions of the same product with different hardware and software payloads.

### SUMMARY

Embodiments of the present invention provide the advantages of a backplane in terms of its ability to physically arrange and secure the connector ends of multiple hard drives, with the speed, simplicity, and reliability of direct wired connections.

Embodiments of the present invention may provide some of the following advantages:

Eliminate drivers and special software needed to operate traditional back planes, since a driver package that will allow the back plane hardware to communicate with all the hard drives on the back plane must be provided.

Fewer points of failure by eliminating the electronics and circuit boards on the backplane itself, and increased simplification since the hard drives are connected to ports by a wire.

Longer life than traditional backplanes since the circuit boards and chips are no longer part of the backplane.

Discrete connections for the HBA to fully control each drive without port multiplication or manipulation from electronic back plane. In embodiments of the present invention, the HBA communicates directly to the hard drive, rather than having the HBA speak to a group of hard drives through a port multiplier requiring a software driver to control drive addressing.

Discrete wiring allows easy monitoring of each drive from the HBA card. The hard drives are connected electronically to the RBA cards by direct wiring. They are physically mounted by a metal grid and cap to restrain the drives.

No interference from the backplane to utilize Hard Drive RAID Control from the HBA card without dealing with drivers and software to utilize electronic back planes. In embodiments of the invention, hardware RAID is implemented on the HBA hard drive controller board. RAID functionality is offloaded to dedicated hardware so it is typically faster, and it simplifies the OS (RAID functionality does not have to be built in, one configures RAID through a software utility and the OS sees a group of RAID drives as a single hardware device. The RAID HBA controller does not recognize or understand Port Multiplier boards. The Software driver that is added to deal with that layer of complexity is on the motherboard/operating system side of things, so it cannot intervene and do the required translation (Hardware RAID is an arrangement between the HBA and hard drives only). So it cannot work with Port Multiplier backplane boards.

### BRIEF DESCRIPTION OF THE DRAWINGS

Embodiments of the invention will now be described in conjunction with the accompanying drawings, wherein:

FIG. 1 illustrates a typical backplane which is the basis for the conventional method of adding multiple hard drives to a server;

FIG. 2 illustrates a Host Bus Adaptor (HBA) card used to connect the multiple drives to the storage server;

FIG. 3 illustrates SFF-8087 to SFF-8087 cables used to connect either hard drives or backplanes which mount and combine signals from multiple hard drives;

FIG. 4 illustrates Standard SFF8087 to Hard drive fan out cable SFF8482;

FIG. 5 illustrates a cable of FIG. 4 modified to have a fastener in accordance with the teachings of this invention;

FIG. 6 illustrates Metal C-channel to mount cables in accordance with the teachings of this invention;

FIGS. 7a and 7b illustrate the present way to connect drives with standard SFF8087 to 4 SFF8482 cables;

FIG. 8 illustrates an embodiment of the present invention that greatly reduces the clutter and allows a mounting means for the hard drives;

FIG. 9a illustrates another embodiment of a backplane in accordance with the teachings of this invention;

FIG. 9b illustrates a pre-wired cable and backplane system using the backplane of

FIG. 9a in accordance with the teachings of this invention;

FIG. 10a illustrates a block diagram of the electrical communication between components of a conventional system; and

FIG. 10b illustrates a block diagram of the electrical communication between components of an embodiment of the present invention in use.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

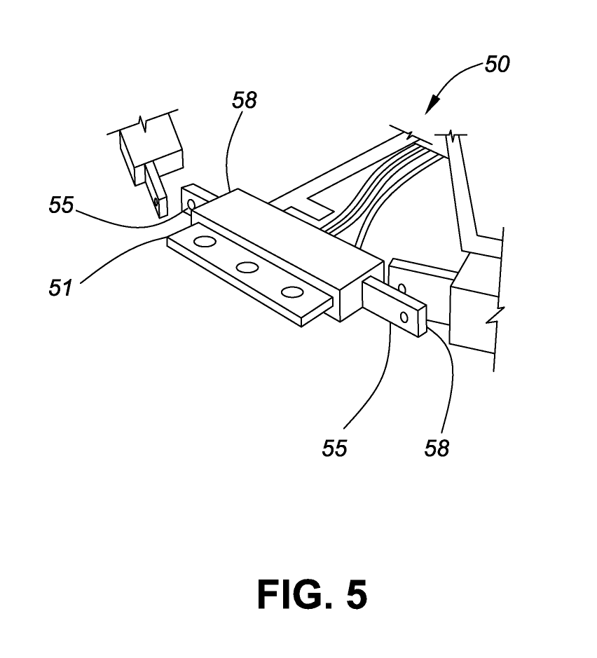

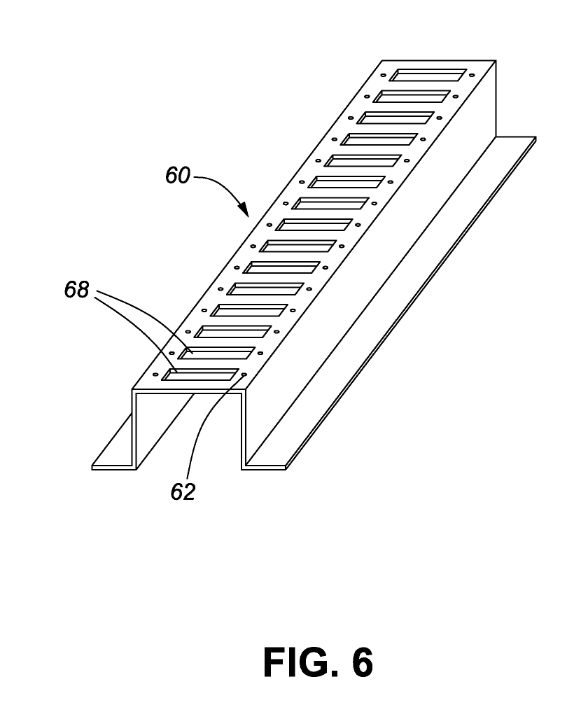

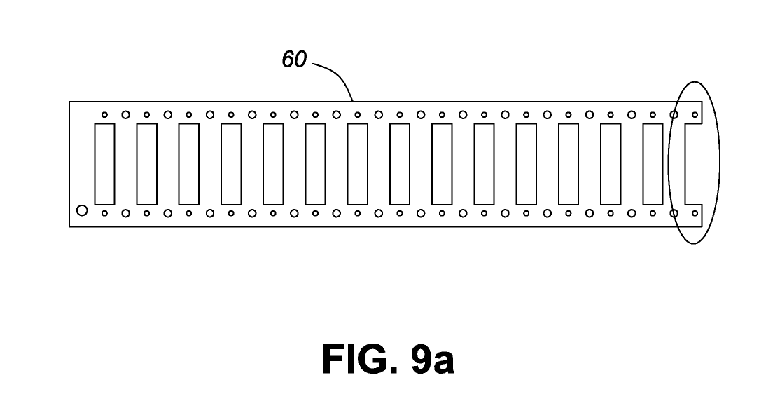

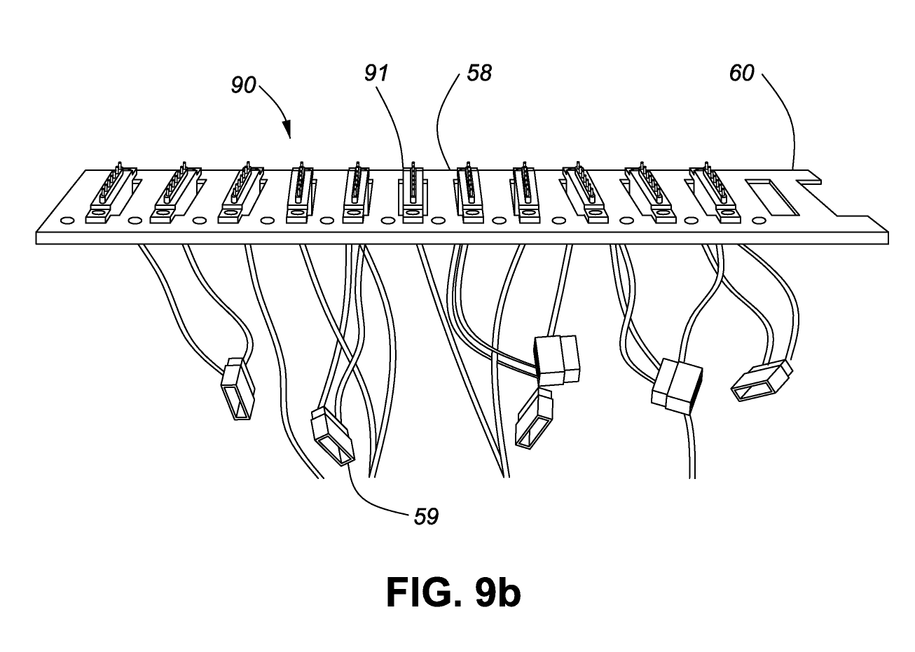

FIG. 5 illustrates a cable system 50 including a first end 58 and a second end (59 shown in FIG. 9). The first end 58 has a hard drive mounting tab 51 with a fastener 55 in accordance with the teachings of this invention. In this embodiment, the hard drive mounting tab 50 is a SFF8482 connector that has a fastener 55 in the form of wings to allow it to be affixed retainers 68 of metal wired backplane 60 (seen in FIG. 6). A backplane 60 in accordance with the teachings of the present invention uses a cable system 50.

In the past, the drives would be mounted in the unit and the cables 40 like the one seen in FIG. 4 would run to the drives after they were mounted. In embodiments of this present system, the cable system 50 with the fastener 55 are affixed to the backplane 60 of FIG. 6, allowing the device to be pre-wired so that the drives can be removed or added without extensive dis-assembly of the device. FIG. 9 illustrates a pre-wired cable and backplane system 90 in accordance with the teachings of this invention.

Referring to the fasteners 55 of FIG. 5, embodiments of the invention include a fastener 55 on the standard SFF8482 connector to allow this cable system 50 to be affixed to a surface of the backplane 60 instead of the need to affix this to a drive. The fastener 55 can be done a clip, bracket or any mechanical means. In the pictured embodiment of FIG. 5, molded wings are used with screw holes 58 placed in the wings to mount to a surface of back plane 60. The backplane 60 then have complementary holes to receive screws 91.

In this embodiment, the fastener 55 has through holes 58 to allow for mounting screws or rivet 91. With such an embodiment, the mechanical backplane 60 of FIG. 6 includes holes 62 to receive the screws or rivets 91. In other embodiments, the fastener 55 can also have built in clips or shanks to allow the hard drive connector to snap into place, with the receiving means 62 in the mechanical backplane being of a complementary form. Embodiments of the present invention includes the advancement of the cabling system 40 of FIG. 4 which allows the user to add drives much easier without massive disassembly and allow more drives to be added in this manner without any huge wire looms or connections.

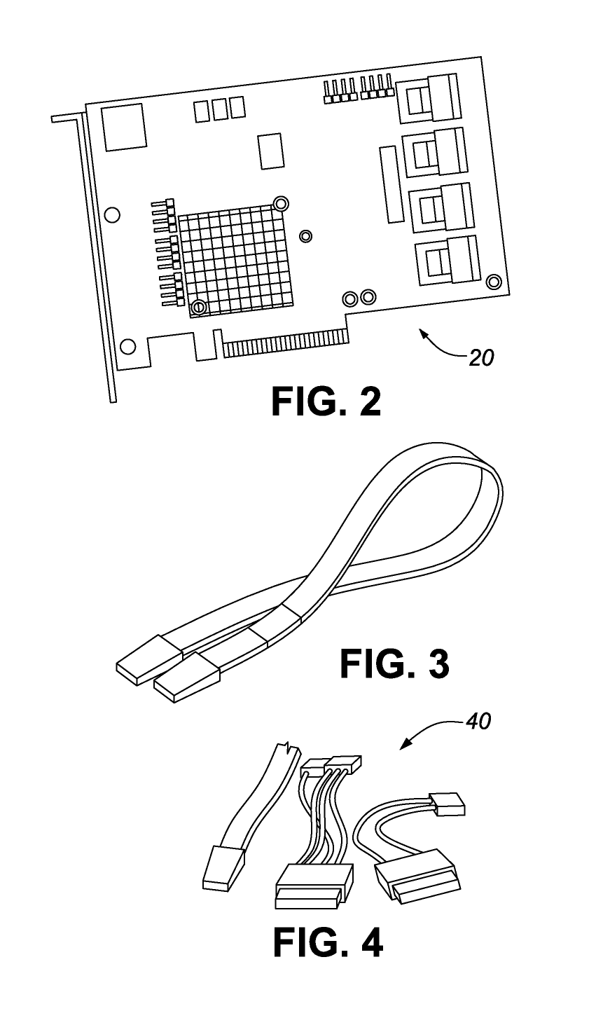

As long as the hard drives maintain the SATA/SAS standard for connection, these cables in accordance with the teachings of this invention will have a long term ability to connect to any HBA card, such as HBA card 20 seen in FIG. 2.

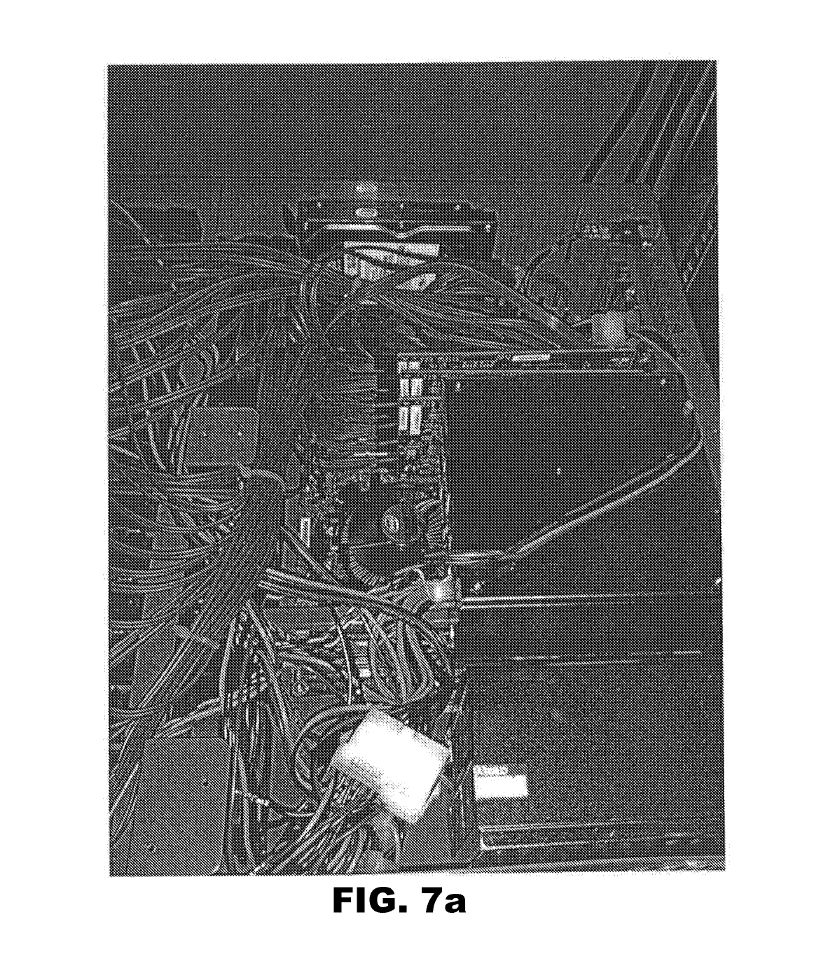

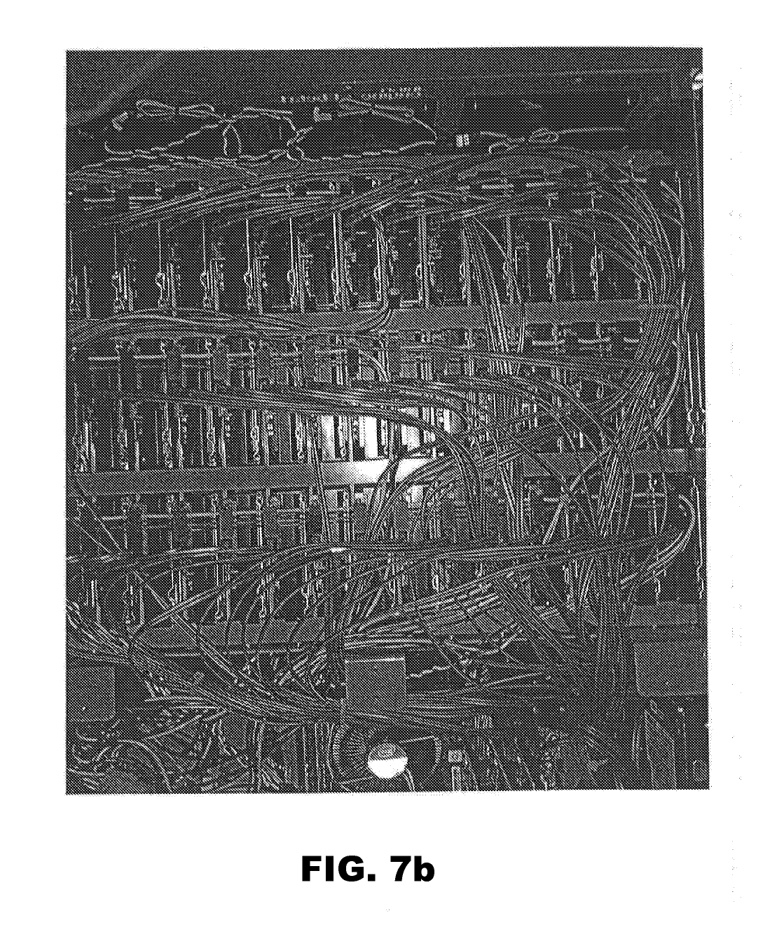

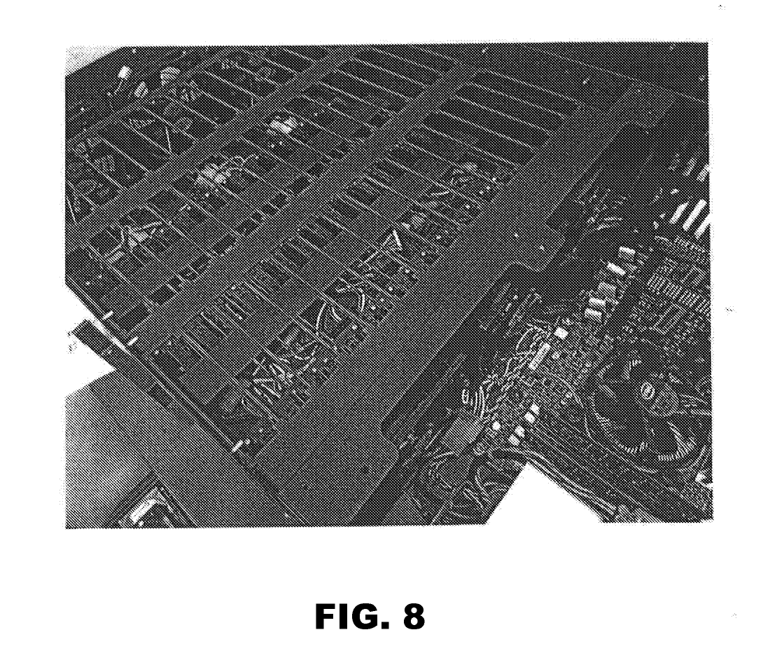

Off-the-shelf HBA cards now provide large numbers of very high speed ports, while minimizing the load on the host computer's resources. This allows direct wired connection of many hard drives. Embodiments of the present invention arranges the direct wired connection such that instead of having a rat's nest of wires as well as physical mounts for hard drives, there is one component that resembles a backplane in look and function (providing physically arranged and constrained connectors that provide mounting constraint for the connector end of the hard drive) and organized wiring with reduced number of connections. The new ability to affix the SFF8482 connectors to a surface gives a huge advantage over standard SFF8482 connectors. Using embodiments of the present invention, the SFF8482 connectors can be attached to a surface and then systematically arrange the wiring in such a way it does not impede hard drive installation and allow the wiring to be systematically harnessed and channeled away. This makes the installation of drives using this method trouble free and very easy to identify wiring locations without tracing wire looms and harness connections, FIGS. 7a and 7b are the industry standard to connect many drives with the standard SFF8482 connectors. FIG. 8 is the improved connections using the system of embodiments of the present invention. FIG. 8, HBA cards are on the mother board with SATA/SAS cables running underneath the metal grating to the hard drive connectors on the metal backplanes. This system is elegant in its simplicity. There is an array of SFF8482 connectors, mounted on the metal base plate and physically arranged next to each other, conceptually similar to a port multiplier backplane. The wired backplane is typically mounted on the bottom of the enclosure (although it may be mounted in other configurations). Hard drives plug in from above. A final step is to apply pressure to the hard drive in order to dampen vibration

Engineering changes in the RBA cards have allowed them to Direct Wire more drives. These engineering changes and lower costs of these HBA cards now allow options to direct wire quantities of drives that in the past could only be done with fewer connections to HBA cards and then port multiplying the HBA outputs on back planes to achieve a higher drive count.

Discrete wiring allows easy monitoring of each drive from the HBA card. Discrete connections for the HBA permit control of each drive without port multiplication or manipulation from electronic back plane.

Previously, backplanes required special software to allow them to be used for RAIDS, their drivers would be needed to communicate with all the drives on the back plane. Software and Hardware RAIDS cannot communicate with the back planes to either identify the drives or allow them to pass data to the drives in an effective manner thus either. Embodiments of the present invention require no special communication drivers to allow setting up RAIDS. Embodiments of the present invention allows HBA ports to connect directly to hard drives, so that no driver is required to direct data through port multipliers. Software RAID can move directly to drives without going through another driver (less complicated). Hardware raid becomes possible. In this way, there is no interference from the back plane to utilize Hard Drive RAID Control from the HBA card without dealing with drivers and software to utilize electronic back planes. The drive multiplexing that occurs on the backplane muddles the hard drive controller's view of each drive, so RAID and drive monitoring functionality is confused. In embodiments of the present inventions, each drive is directly connected to the motherboard, therefore there is no need for software to allow the motherboard to recognize all the drives on a back plane. As for the bandwidth issues when each connection to the hard drives is at full transfer speed per drive and does not share one connection at full transfer speed with multiple drives when using back planes.

FIG. 6 illustrates a C-channel backplane 60 to mount cable system 50 in accordance with the teachings of this invention. These would be mounted to a backplane of any material as depicted in FIG. 6 as C-channel creating a mechanical back panel. The C-Channel backplane 60 comprises of a row or geometric shape of any orientation of the drive connectors in FIG. 5. In this embodiment as FIG. 6 this is a row of drives but can be of any geometric shape of drive configurations. Each drive connector is affixed to the C-Channel backplane 60. The C-channel backplane 60 can be any suitable material such as any appropriate metal. The C-channel backplane 60 has the same purpose as a back plane to allow the drives to be mounted to a system. The backplane 60 in accordance with the teachings of this invention could also be in the form of that seen in FIG. 9a, or any other suitable configuration.

Traditional backplanes require driver software packages to allow them to connect to the drives; usually without driver software packages they will only allow the use of the partial drives attached to the back plane. Embodiments of this present invention allow each drive to be connected directly to the motherboard without the need for back planes or drivers. In this way, embodiments of the present invention eliminate drivers and special software to operate traditional backplanes.

Another issue with traditional backplane and HBA systems is they need to have the same manufacturer of communication hardware chip sets making the choice of back planes and NBA card limited to the same families of chipset. In contrast, embodiments of the present invention eliminate the need for this requirement of chipset compatibility. A chipset is a set of electronic components in an integrated circuit that manages the data flow that allows communication from HBA to backplane. Chipsets are found on the HBA and another set are found on the back plane. These chip sets will loosely follow SATA/SAS protocols but many manufacturers provide some proprietary communication commands and protocols. These commands will usually not allow communication between HBA cards and back planes of different ChipSet manufacturers.

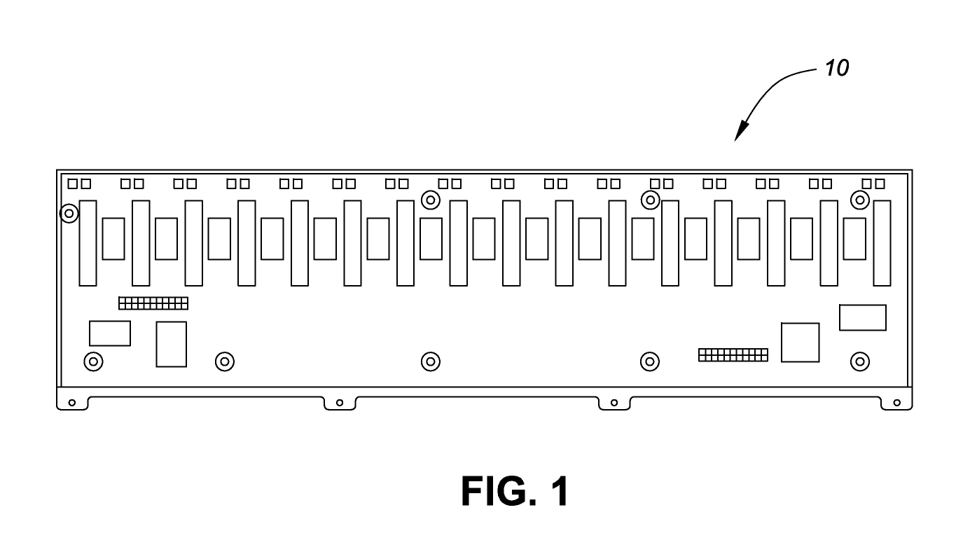

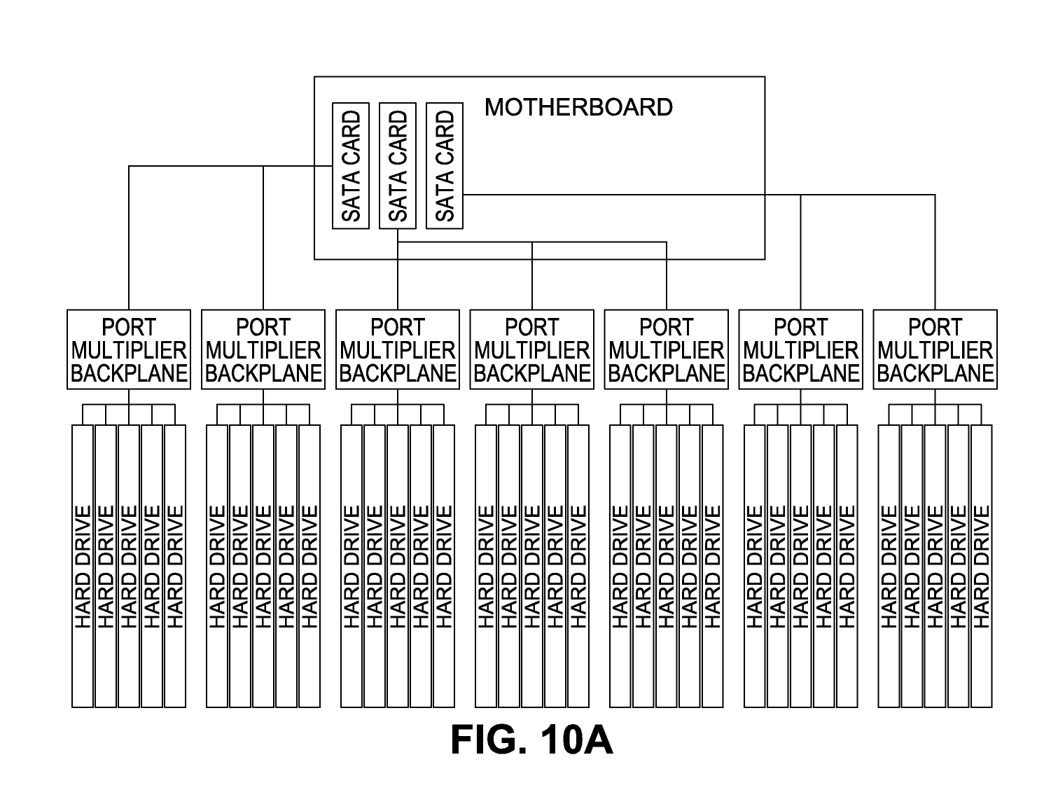

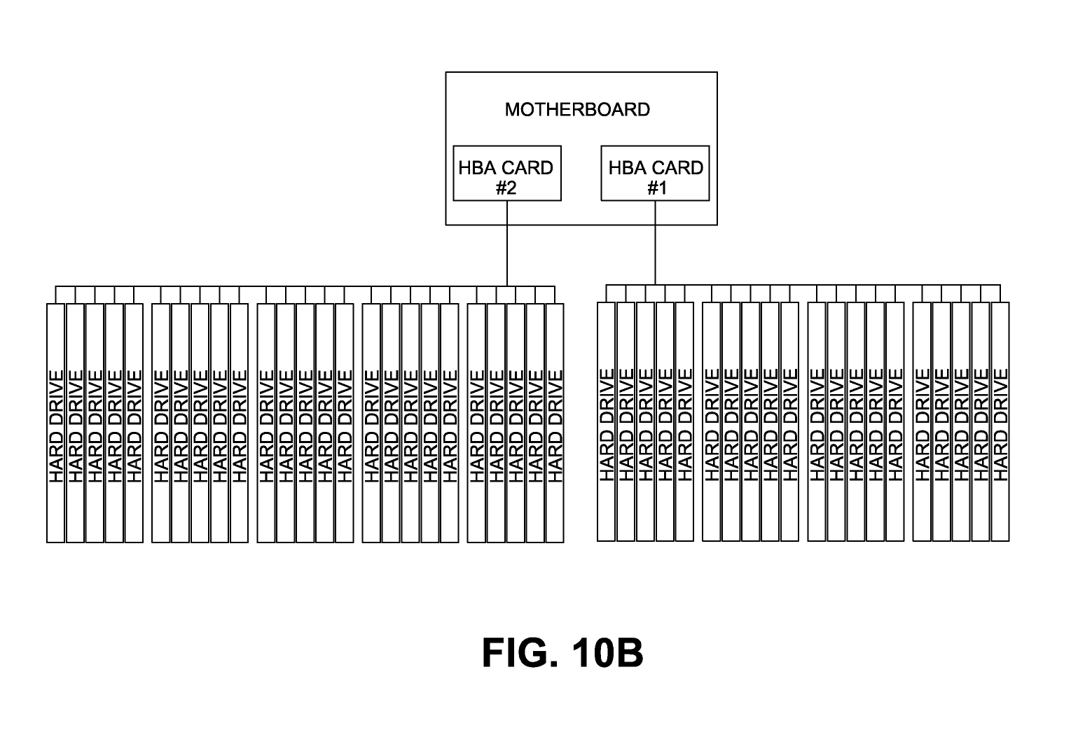

Embodiments of the invention can also offer the advantage of fewer points of failure and elimination of the electronics on the backplane. In a conventional system, backplanes 10 (such as those seen in FIG. 1) consist of a circuit board 11 with many passive components 12 like resistors, capacitors, diodes and voltage regulators. They also have processing unit and communication chipsets hard wired to the back planes to allow them to communicate with all the drives on each back plane and with the host HBA. In accordance with the teachings of the present invention, elimination of the circuit board backplanes results in elimination of passive electronic components and integrated circuits, which in turn increases reliability. FIG. 10a illustrates a block diagram of the electrical communication between components of a conventional system. FIG. 10b illustrates a block diagram of the electrical communication between components of an embodiment of the present invention in use.

In one practical embodiment, the Applicants utilize a Syba PCI Express SATA II 4-Port RAID Controller Card SY-PEX40008 HBA card with 4 ports and we attach 3 AC-SAN-5PMBP 5 Bay Port Multiplier Backplane, which permits expansion to 3 ports on the SYBA HBA card to 15 Drives. The process of mounting these cables to the mechanical back plane provides the means to easily attach and remove hard drives to a storage system without the mess of complicated cabling of FIG. 7A and 7B. Embodiments of the invention provides a means to easily track and distinguish each drive in the storage matrix standardizing the cable matrix on the mechanical backplane to consistently identify the physical location of each hard drive in the storage system and eliminate the possibility of wiring the drives incorrectly if the cable ends did not have the mounting tabs/means having them just attach directly to the hard drives without attaching them to the mechanical back planes first. It should be noted that in many embodiments, the SFF8087 connectors could be replaced with any suitable HBA/hard drive port connector, and SFF8482 connectors could be any suitable hard drive/power connector.

Numerous modifications may be made without departing from the spirit and scope of the invention as defined in the appended claims.

What is claimed is:

1. A cable and backplane system for mounting a wiring system that permits connection of hard drives directly to a mother board of a computer, the cable and backplane system comprising:
a mechanical backplane having multiple retainers defined in a top surface thereof;
a cable having a first end and a second end, the first end of the cable being mounted to one retainer in the mechanical back plane such that the first end can receive a hard drive, and the second end connectable to be in communication with the motherboard; and
a fastener attached to the first end, the fastener anchoring the cable to the retainer to anchor the one or more hard drives;
wherein the mechanical backplane can be pre-wired with cables.

2. The cable and backplane system of claim 1, wherein the fastener comprises tabs to receive mounting screws to screw the first end to the retainer on the mechanical back plane.

3. The cable and backplane system of claim 1, wherein the fastener comprises clips or shanks to allow the hard drive to snap into place during use.

4. The cable and backplane system of claim 1, wherein the mechanical backplane is a C-channel shape.

5. The cable and backplane system of claim 4, wherein the multiple retainers are in a row.

6. A mechanical backplane for mounting a wiring system that permits connection of hard drives directly to a mother board of a computer, the backplane comprising:
multiple retainers defined in a top surface thereof, each retainer adapted to receive a first end of a cable such that the first end can receive a hard drive; and
receiving means in each retainer for anchoring the cable to the retainer to anchor the hard drive.

7. The mechanical backplane of claim 6, wherein the receiving means comprises screw holes to receive mounting screws to screw the first end to the retainer on the mechanical back plane.

8. The mechanical backplane of claim 6, wherein the mechanical backplane is a C-channel shape.

9. The mechanical backplane of claim 8, wherein the multiple retainers are in a row.

10. A cable as part of a cable and backplane system for system for mounting a wiring system that permits connection of hard drives directly to a mother board of a computer, the cable comprising:
a first end and a second end, the first end of the cable being mounted to one retainer in a mechanical back plane such that the first end can receive a hard drive, and the second end. connectable to be in communication with the motherboard; and
a fastener attached to the first end, the fastener anchoring the cable to the retainer to anchor the one or more hard drives,

11. The cable of claim 10, wherein the second end is connected to a HBA card.

12. The cable claim 10, wherein the fastener comprises tabs to receive mounting screws to screw the first end to the retainer on the mechanical back plane.

13. The cable of claim 10, wherein the fastener comprises clips or shanks to allow the hard drive to snap into place during use.
